(19) United States
(12) Patent Application Publication
(10) Pub. No.: US 2021/0402512 A1
(43) Pub. Date: Dec. 30, 2021

(54) METHOD FOR PRODUCING AN OPTICAL COMPONENT BY MEANS OF LASER RADIATION

(71) Applicants: Fraunhofer-Gesellschaft zur Förderung der Angewandten Forschung E.V., München (DE); Friedrich-Schiller-Universität Jena, Jena (DE)

(72) Inventors: Malte Per SIEMS, Jena (DE); Stefan NOLTE, Jena (DE); Daniel RICHTER, Jena (DE); Ria KRÄMER, Jena (DE); Thorsten Albert GOEBEL, Jena (DE); Maximilian HECK, Jena (DE)

(73) Assignees: Fraunhofer-Gesellschaft zur Förderung der Angewandten Forschung E.V., München (DE); Friedrich-Schiller-Universität Jena, Jena (DE)

(21) Appl. No.: 17/270,470

(22) PCT Filed: Aug. 23, 2019
(86) PCT No.: PCT/EP2019/072605

§ 371 Date: Sep. 3, 2021

(30) Foreign Application Priority Data
Aug. 23, 2018 (DE) 10 2018 120 568.6

(51) Int. Cl. B23K 26/0622; B23K 26/00

(52) U.S. Cl. CPC B23K 26/0624; B23K 26/0006

(57) ABSTRACT

The invention relates to a method for producing an optical component (1) by means of laser radiation. The object of the invention is that of providing a method that is improved compared with the prior art, which method allows for the correction of deviations of the optical functionality of the component from specified target parameters. For this purpose, the method according to the invention comprises the following method steps:
generating a structure in the material of the component (1) which gives the component (1) an optical functionality, and
modifying the refractive index in the material of the component (1) by means of laser beams in a pre- and/or post-processing step, i.e. before or after the generation of the structure, in order to correct deviations of the optical functionality of the component (1) from specified target parameters.

The invention relates to a method for producing an optical component by means of laser radiation.

There are various approaches for producing optical components, in order to equip them with particular functionalities. In this case, in particular the use of short or ultrashort laser pulses (pulse duration in the fs to ps range) for modifying transparent, partially transparent, or also absorptive materials, in volumes or at the surface, has proven itself as a key tool. The material of the component is heated in a locally restricted manner by the high power of the laser pulses, or up to the threshold after which a plasma is generated in the material by the individual laser pulse, or therebelow. As a result, a structure is generated as a corresponding locally restricted modification of the refractive index in the material of the component, in the focus of the laser radiation, which is the basis for the function, e.g. as an optical grating.

Irrespective of the selected method for generating the refractive index modifications which provide the component with its functionality, deviations from the target parameters may arise. The target parameters determine the optical function of the generated structure, e.g. for a Bragg grating, the dispersion and the central operating wavelength, i.e. wavelength of maximum reflection (or minimal transmission). Possible reasons are inter alia material inhomogeneities or, in the case of optical waveguides (e.g. optical fibers), material deviations between different waveguides (in the case of multicore fibers or waveguide systems), or along the relevant waveguide. The generation of the structure determining the optical functionality can itself also lead to deviations from specified target parameters arising (e.g. by the input of heat and the resulting material stresses). Such deviations can barely be compensated or corrected in the prior art, when producing the optical components.

Various approaches for overcoming these problems are known from the prior art. For example, in the production process of waveguides or waveguide systems, e.g. multicore fibers, significant effort is made to create the waveguides so as to be as uniform as possible, both with respect to the symmetry and to the material properties. For waveguide systems comprising just one waveguide, the material deviations can be corrected, within certain limits, both thermally and by the action of mechanical force. This is almost impossible to still implement if the waveguide system comprises more than one waveguide, since all the waveguides are always influenced in a similar manner.

Against this background, the object of the invention is that of providing a method that is improved compared with the prior art, which method allows for the correction of deviations of the optical functionality of the component from specified target parameters.

The invention achieves this object by a method according to claim 1, said method comprising the following method steps:
generating a structure in the material of the component which gives the component an optical functionality, and
modifying the refractive index in the material of the component by means of laser beams in a pre- and/or post-processing step, i.e. before or after the generation of the structure, in order to correct deviations of the optical functionality of the component from specified target parameters.

According to the invention, pre- and post-processing takes place in order to reduce undesired deviations and to achieve the desired target parameters as precisely as possible. The invention is suitable for producing components having different functionalities, having periodic or also aperiodic structures, in usually transparent components, such as optical fibers.

In a possible embodiment, deviations from target parameters in an already structured component are first determined, for which purpose inter alia microscopy methods such as phase contrast or nonlinear microscopy (SHG, THG) are suitable. Material deviations from the desired structure can also be determined by means of spatially resolved Raman spectroscopy. In particular, deviations of the spectral properties can be determined by means of s spectroscopy. If an interferometer is additionally used, the dispersive function can also be measured. On this basis, it is then possible, in the post-processing step, for refractive index modifications to be introduced, according to the invention, in order to correct the determined deviations from the target parameters in a targeted and precise manner.

For the modification of the material of the component in the pre- or post-processing step, pulsed laser radiation is expediently used, wherein the pulse duration is from 10 fs to 10 ps, and the central wavelength is in the range of from 150 nm to 10 μm. A short pulse laser (or ultrashort pulse laser) of a type that is known per se and is commercially available, for example a titanium-sapphire laser or also a mode-coupled fiber laser, in which an optical fiber doped with rare earth ions is used as the laser medium, which optical fiber is optically pumped by means of a laser diode, is expediently used as the source for generating laser radiation of this kind. In order to achieve the required powers, the generated laser radiation is expediently amplified by means of one or more optical amplifiers which are also of a type that is known per se and is commercially available.

In a particularly preferred embodiment of the method according to the invention, in the pre- and/or post-processing step beam shaping and/or beam deflection of the laser radiation directed onto the component takes place, in order to generate a spatially variable modification of the refractive index in the material of the component. In this case, the beam shaping and/or beam deflection expediently takes place using controllable focusing optics and/or adaptive optics. As a result of the method according to the invention, the spatially variable modification of the refractive index advantageously is superimposed on the structure that determines the optical functionality in the material of the component, such that the finished component fulfils the target specifications at a high degree of precision. Adaptive optics are particularly suitable for deflecting and focusing the laser radiation. The adaptive optics can be used in order to modify the intensity progression over the cross section of the laser beam, and to thus shape the beam. The required direction change and focusing of the laser beam is achieved by means of the s deflection and focusing optics, for which purpose said optics are actuated by a control computer during the pre- and/or post-processing step. In the simplest case, a combination of a deflection mirror and focusing optics (for example in the form of an adjustable arrangement consisting of spherical or cylindrical lenses or also freeform optics and/or curved mirrors) is used. Alternative implementations are possible, for example on the basis of diffractive optics. As a result, targeted local, as well as extensive, pre- and/or post-processing is possible, for example in that the laser beam used for the refractive index modification is guided (scanned) over the component. The combination of static optical components with adjustable optical components for the pre- and/or post-processing makes it possible for a flexible local and also extensive modification to take place.

According to the invention, the beam shaping preferably takes place using adaptive optics. Adaptive optical elements are known per se from the prior art, for example in the form of mechanically deformable or adjustable mirrors or lenses. The adaptive optical element allows for static or dynamic control of the beam shape. Within the meaning of the invention, an adaptive optical element is any element which allows for adjustable control of the wavefront and intensity progression of the laser radiation. As a result, precise control of the intensity and wavefront progression in the material of the component is made possible. Any statically or dynamically adjustable reflective or transmissive element, known from the prior art, which element modifies the beam shape, is suitable as the adaptive optical element. The adaptive optics used according to the invention allow for the targeted influencing of the resulting modification, since for example the use of permanently or dynamically adaptive mirrors makes it possible for undesired local material deviations in the material to be flexibly addressed, individually.

In order to generate the spatially variable modification it is advantageously possible, in the pre- and/or post-processing step, for the pulse energy, the repetition rate and/or the number of laser pulses applied in the material of the component, per volume or per surface area, to be varied. For this purpose, the s laser (or an associated pulse selector or attenuator) can be actuated accordingly, in a simple manner, by means of the control computer used for the pre- and/or post-processing of the component.

In a further preferred embodiment of the method according to the invention, the component is clamped in a retainer during the modification of the refractive index, and/or an immersion fluid is used for coupling the laser radiation into the material of the component. The retainer makes it possible to overcome a possible surface curvature or warpage of the component (e.g. curvature of the fiber surface). An immersion fluid improves the coupling of the laser radiation into the material of the component.

The method according to the invention is advantageously possible for producing optical components such as optical fibers or optical fiber systems, in particular single core or multicore optical fibers (with or without a coating). In the case of fibers comprising a coating (e.g. made of polymer material), the laser radiation used for modifying the refractive index during the post-processing can also be axially coupled into the fiber.

The optical functionality of the component can be that of an optical grating, in particular a fiber Bragg grating, an aperiodic fiber Bragg grating, a long-period grating, or a volume Bragg grating. The target parameter to be set according to the invention can be a central operating wavelength and/or a dispersion of the component.

Exemplary embodiments of the invention will be explained in greater detail in the following, with reference to the drawings, in which:

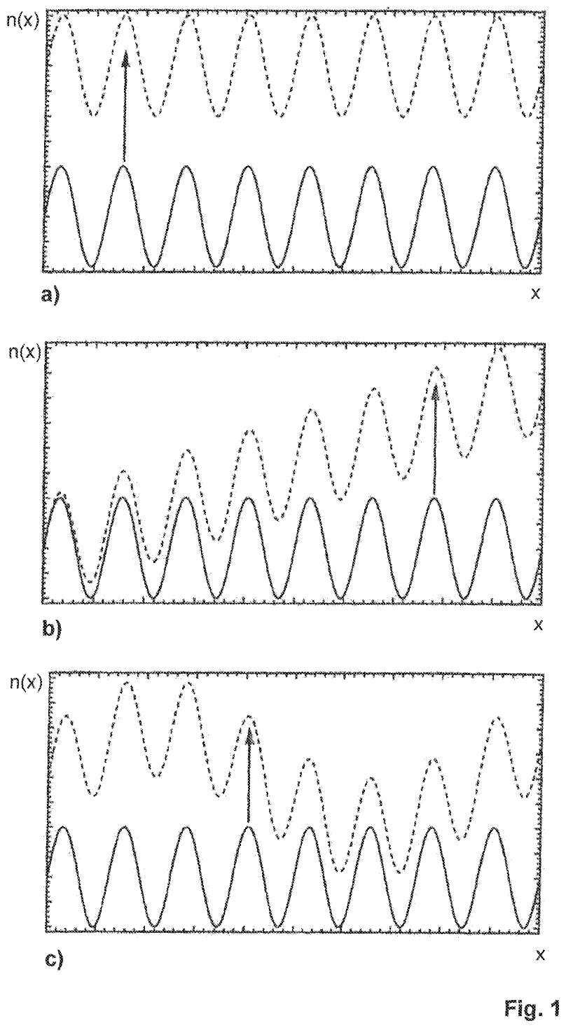

FIG. 1 is a schematic view of the refractive index modification according to the invention: a) uniform modification, b) linearly increasing modification of the refractive index, c) variable modification;

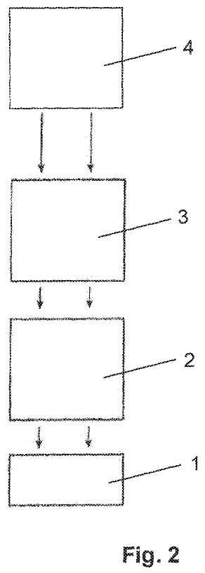

FIG. 2 is a schematic view of an optical arrangement used for the method according to the invention.

The graphs of FIG. 1 show different refractive index profiles n(x) along the longitudinal axis x of an optical fiber. The solid curve in each case specifies the refractive index profile n(x), which was first generated as a structure in the material of the component 1, in order to provide the component with its optional functionality, in this case a periodic structure (Bragg grating) as a narrow-band reflector. The arrow in each of the graphs indicates how the refractive index is modified in a post-processing step, such that the refractive index profile n(x) according to the dashed curve, in each case, results. In this case, the local change in the refractive index does not necessarily always have to be positive.

FIG. 2 schematically shows an arrangement, by means of which, according to the invention, a refractive index modification can be introduced into the material of the component, in a pre- or post-processing step.

An ultrashort pulse laser 2 having a central wavelength from the range of 150 nm to 10 μm, having possible pulse lengths in the range of from 10 fs to 10 ps, is used as the laser source. All types of transparent, partially transparent, or absorptive materials (for the laser central wavelength used in each case) are suitable as materials of the component 1 to be processed, which materials may be provided for example as an optical fiber with and without a coating, as a bulk material with and without waveguides, etc. In order to overcome a possible surface curvature or another curvature of the component (e.g. curvature of the fiber surface), said component can also be located in a corresponding retainer (not shown), optionally supplemented by an immersion fluid for coupling in the laser radiation used for refractive index modification.

The use of the ultrashort laser pulses allows for the local modification of the material. A strongly localized change in the refractive index is thus possible. Furthermore, the ultrashort pulses of the laser radiation allow for the modification of transparent (or partially transparent) materials. The region in the material of the component to be processed is expediently addressed by means of beam shaping or scanning of the laser beam. The magnitude of the refractive index change can be controlled inter alia by the pulse energy, the number of pulses per surface area or per volume, and the repetition rate of the laser.

The centrally reflected wavelength of a Bragg grating can be changed by means of a uniform change of the refractive index, as shown in FIG. 1a.

A modification of the refractive index that increases (or drops) to one side of the component, as shown in FIG. 1b, can be used to change the dispersive and reflective properties.

Furthermore, nonlinear progressions of the refractive index modification are conceivable, in order to obtain desired complex dispersion and reflection profiles. An example of how a nonlinear progression of this kind, impressed on a periodic structure, can appear, is shown in FIG. 1c.

In order to carry out the pre- or post-processing according to the invention, various optical assemblies can be used. It is possible for example, as indicated in FIG. 2, for imaging focusing optics 3 (comprising spherical or cylindrical lenses, freeform optics, curved mirrors, etc.), if necessary also in combination with flexible adaptive optics 4, to be used for beam shaping, for the purpose of targeted local modification. As a result, both extensive and also local pre- and/or post-processing is possible. In the event of post-processing of structures inside or in the effective region of an optical fiber (e.g. inside a coated fiber), the laser radiation can also be coupled into these.

1. Method for producing an optical component (1) by means of laser radiation, comprising the following method steps:
generating a structure in the material of the component (1) which gives the component (1) an optical functionality, and
modifying the refractive index in the material of the component (1) by means of laser beams in a pre- and/or post-processing step, i.e. before or after the generation of the structure, in order to correct deviations of the optical functionality of the component (1) from specified target parameters.

2. Method according to claim 1, characterized in that the laser radiation used for modifying the refractive index in the pre- and/or post-processing step is pulsed, wherein the pulse duration is from 10 fs to 10 ps, and the central wavelength is in the range of from 150 nm to 10 μm.

3. Method according to claim 1, characterized in that, in the pre- and/or post-processing step, beam shaping and/or beam deflection of the laser radiation directed onto the component (1) takes place, in order to generate a spatially variable modification of the refractive index in the material of the component (1).

4. Method according to claim 3, characterized in that the beam shaping and/or beam deflection is achieved by means of focusing optics (3) and/or adaptive optics (4).

5. Method according to claim 3, characterized in that the spatially variable modification of the refractive index is superimposed on the structure that determines the optical functionality in the material of the component (1).

6. Method according to claim 3, characterized in that, in order to generate the spatially variable modification, the pulse energy, the repetition rate and/or the number of laser pulses applied in the material of the component (1), per volume or per surface area, is varied.

7. Method according to claim 1, characterized in that the component (1) is clamped in a retainer during the modification of the refractive index, and/or an immersion fluid is used for coupling the laser radiation into the material of the component (1).

8. Method according to claim 1, characterized in that the optical component (1) is an optical fiber or an optical fiber system, in particular a single core or multicore optical fiber.

9. Method according to claim 1, characterized in that the optical functionality is that of an optical grating, in particular a fiber Bragg grating, an aperiodic fiber Bragg grating, a long-period grating, or a volume Bragg grating.

10. Method according to claim 1, characterized in that the target parameters determine a central operating wavelength and/or a dispersion of the component (1).
